(19) United States
(12) Patent Application Publication
(10) Pub. No.: US 2002/0031148 A1
(43) Pub. Date: Mar. 14, 2002

(54) Clock producing circuit and semiconductor integrated circuit for communication

(76) Inventors: Keiki Watanabe, Tachikawa (JP); Satoshi Ueno, Ome (JP); Takashi Harada, Hidaka (JP); Atsushi Takai, Koganei (JP); Ryoji Takeyari, Koganei (JP)

Correspondence Address: MATTINGLY, STANGER & MALUR P.C., ATTORNEYS AT LAW, 104 EAST HUME AVENUE, ALEXANDRIA, VA, 22301, US

(21) Appl. No.: 09/864,200

(22) Filed: May 25, 2001

(30) Foreign Application Priority Data
May 30, 2000 (JP) 2000-160917

(51) Int. Cl. H04L 12/56

(52) U.S. Cl. 370/503; 370/419

(57) ABSTRACT

A semiconductor integrated circuit apparatus having a buffer to which a received input data is fetched with an input clock includes a selector for selecting one of the input clock and an external clock having a stabilized phase, a PLL circuit operative with an output of the selector as a reference clock, and a read clock generating circuit for generating a read clock by frequency-dividing an output of the PLL circuit.

### BACKGROUND OF THE INVENTION

The invention relates to a technique which is effective when it is applied to a clock producing circuit using a PLL (phase locked loop) circuit and, for example, relates to an LSI (large scale semiconductor integrated circuit) apparatus for communication having therein a clock producing circuit for producing a clock signal for fetching serial data.

In recent years, in an LSI for data communication, a PLL circuit has been used to extract a timing clock from input serial data or produce a clock signal of a stable phase for fetching the input serial data on the basis of an input clock.

Heretofore, in a system to which a data fetch clock is supplied together with serial data, the data may be outputted from the system after it is once fetched into an input buffer. In order to produce a clock which gives data reading timing therein, a PLL circuit is used which employs an input clock φin as a reference clock, compares a phase of the reference clock with that of a feedback clock φf, and produces a clock such that the phases of both clocks coincide with each other, as in a semiconductor integrated circuit apparatus shown in FIG. 8. In such a PLL circuit, if the phase of the data fetch clock which is sent together with the inputted serial data is relatively stable, there will be no particular problem.

In FIG. 8, VCO denotes a voltage controlled oscillator; PHC a phase comparator for detecting a phase difference between the input clock φin and feedback clock φf; LPF a loop filter for generating a voltage according to the phase difference and supplying it to the voltage controlled oscillator VCO; DVD a frequency divider for frequency dividing an oscillation output of the VCO; IBF an input buffer (memory) such as an FIFO (First-in First-out) memory for fetching input serial data Din on the basis of the input clock φin and outputting the data on the basis of a clock CLK from the frequency divider DVD; and DSP a signal processing section for performing a signal process such as a parallel-serial conversion or the like.

### SUMMARY OF THE INVENTION

The present inventors examined the above PLL circuit to newly develop an LSI for optical communication, and have found that there is a case where the phase of the input data fetch clock is not stable in dependence on a construction of a user system using the LSI for communication. That is, although the input data fetch clock is inputted simultaneously with the data and has frequency information, a phase relation with the data is not guaranteed. There is, consequently, a case where the data cannot be accurately transferred. As shown in FIG. 9, the inventors examined a PLL circuit which receives a reference clock φ0 whose frequency and phase are stable separately from the input clock φin, uses the reference clock φ0 as a reference clock, compares a phase of the reference clock with that of the feedback clock φf, and produces the clock CLK such that the phases of both clocks coincide.

According to the above system, however, since there is a case where the phase of the input clock φin is largely deviated from that of the clock CLK produced from the external reference clock φ0, there is still a fear that the data cannot be accurately transferred due to such a large phase deviation. There is a case where the phase of the input data fetch clock φin is stable in dependence on the construction of the user system using the communication LSI. In such a case, such a problem can be avoided by producing the read clock CLK on the basis of the input clock φin. If different LSIs in which forms of the clock producing circuits are different are designed in correspondence to those systems, however, costs of an LSI chip become more expensive than they are needed.

In U.S. Pat. No 5,761,203 issued on Jun. 2, 1998, to Luis E. Morales, assigned to Lucent Technologies Inc., Murray Hill, N.J., there is shown an apparatus for synchronous or asynchronous recovery of a signal in an ATM network, comprising a first timing signal generator based on timing information included in a data stream and a second timing signal generator based on a clock source, wherein either one of outputs of the signal generators is selected by a switch, and the reading operation of a buffer is executed by the selected output.

It is an object of the invention to provide a semiconductor integrated circuit for communication having a buffer which fetches input data on the basis of an input clock and outputs it, wherein an accurate data transfer is enabled even when a phase of the input clock is unstable.

Another object of the invention is to provide a semiconductor integrated circuit apparatus having a clock producing circuit which can cope with a case where a clock which is inputted together with input data and a case where an external clock different from such a clock is used as a reference clock.

The above and other objects and new features of the present invention will become more apparent from the description and the accompanying drawings of the present specification.

According to an aspect of the invention, there is provided a semiconductor integrated circuit apparatus for communication having a buffer in which input data is written by a write clock based on an input clock concerned with the input data and from which the written data is read out by a read clock, comprising: clock switching means for selecting either the input clock or a stable external clock which is supplied from an outside on the basis of a selection signal from the outside; and a circuit for producing the read clock on the basis of an output of the clock switching means. The read clock producing circuit comprises: a PLL circuit for receiving the output of the clock switching means and generating a PLL clock which is locked therewith; and a frequency divider for frequency dividing the PLL clock and generating the read clock.

### BRIEF DESCRIPTION OF THE DRAWINGS

FIG. 1 is a block diagram of a semiconductor integrated circuit apparatus including a clock producing circuit according to an embodiment of the invention;

FIG. 2A is a block diagram of the semiconductor integrated circuit apparatus including the clock producing circuit according to the embodiment of the invention, in which a data transmitting circuit of an LSI for optical communication is constructed;

FIG. 2B is a block diagram showing an example of a construction of an overflow/underflow detecting circuit which can be used in the apparatus of FIG. 2A;

FIG. 2C is an operation timing chart showing the operation of the overflow/underflow detecting circuit shown in FIG. 2B and shows the operation in the case where no overflow/underflow is detected;

FIG. 2D is an operation timing chart showing the operation of the overflow/underflow detecting circuit shown in FIG. 2B and shows the operation in the case where the underflow is detected;

FIG. 3 is an operation timing chart showing the operation of an FIFO buffer constructing a data transmitting circuit shown in FIG. 2A;

FIG. 4 is a logical constructional diagram showing an example of a construction of a write clock producing circuit which can be used in the data transmitting circuit shown in FIG. 2A;

FIG. 5 is an operation timing chart showing the operation when a reset state of the data transmitting circuit shown in FIG. 2A is released;

FIG. 6 is a timing chart showing relations among a write clock, a read clock, and input data of the FIFO buffer constructing the data transmitting circuit shown in FIG. 2A;

FIG. 7 is a block diagram showing a schematic construction of a communication system using a transceiver chip as an example of the LSI for communication having the data transmitting circuit according to the embodiment of the invention;

FIG. 8 is a circuit constructional diagram showing an example of a semiconductor integrated circuit apparatus having a clock producing circuit including a PLL circuit; and

FIG. 9 is a constructional diagram of a circuit having a clock producing circuit including a PLL circuit examined prior to the present invention.

### DETAILED DESCRIPTION OF THE EMBODIMENTS

Embodiments of the invention will now be described with reference to the drawings.

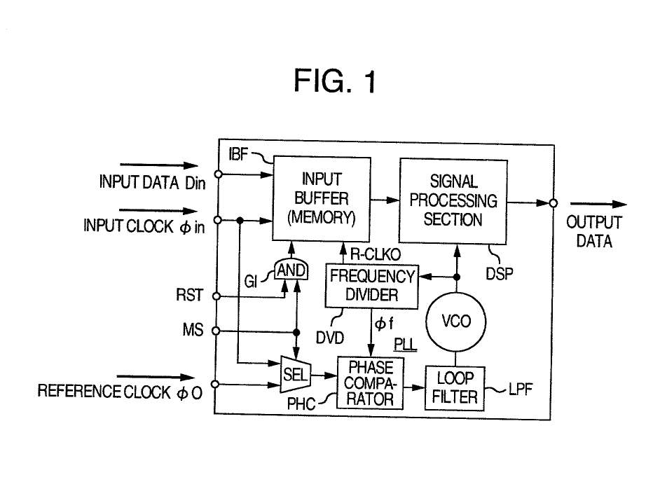

FIG. 1 schematically shows a structure of a semiconductor integrated circuit apparatus according to the embodiment of the invention.

As shown in FIG. 1, the semiconductor integrated circuit apparatus including a clock producing circuit is constructed in a manner such that a selector SEL is provided at the front stage of a PLL circuit comprising the phase comparator PHC, loop filter LPF, and voltage controlled oscillator VCO, and either the input clock φin which is supplied to an input clock port and the external reference clock φ0 whose frequency and phase are stable and which is supplied to an external clock port is selected by the selector SEL and supplied to the phase comparator PHC. A signal from the frequency divider DVD for frequency dividing an output of the voltage controlled oscillator VCO is supplied as a feedback clock φf to the phase comparator PHC. The phase comparator PHC compares the phase of the input clock φin or external reference clock φ0 with that of the feedback clock φf, generates a voltage according to a phase difference, and supplies it to the voltage controlled oscillator VCO, so that the PLL circuit operates so as to make the phases coincide. The clock producing circuit is constructed by the PLL circuit and the frequency divider DVD.

The apparatus is also provided with the input buffer IBF for fetching (writing) the input data Din which is supplied to the input data port synchronously with the input clock φin and outputting the written data synchronously with the clock CLK from the frequency divider DVD. A reset RST signal which is supplied from the outside to a control signal port can be inputted to the input buffer IBF through an AND gate G1. When the reset RST signal from the outside is inputted to the input buffer IBF through the AND gate G1, for example, the input data fetching operation synchronized with the input clock φin is interrupted. The data written in the input buffer IBF is read out synchronously with a read clock R-CLK0 from the frequency divider DVD, supplied to the signal processing section DSP at the next stage, subjected to a signal process such as a parallel-serial conversion or the like, and sent as output data to an output data port. The signal processing section DSP is also made operative by the clock produced from the PLL circuit.

Further, a mode selection signal MS which is supplied from the outside to a mode selection signal port is inputted to the AND gate G1. When the mode selection signal MS is at the high level, the reset RST signal from the outside is supplied to the input buffer IBF through the AND gate G1. The mode selection signal MS is also supplied as a switching control signal to the selector SEL. The selector SEL operates in a manner such that when the mode selection signal MS is at the high level, the selector SEL supplies the external reference clock φ0 to the phase comparator PHC, and when the mode selection signal MS is at the low level, the selector SEL supplies the input clock φin to the phase comparator PHC.

When the input clock φin is supplied as a reference side clock to the phase comparator PHC, the PLL circuit operates so as to make the phase of the feedback clock φf coincide with that of the input clock φin, so that the phase of the produced clock, that is, the clock CLK which is outputted from the frequency divider DVD also coincides with the phase of the input clock φin. When the phase of the input clock φin is stable, therefore, by using the input clock φin as a reference side clock of the PLL circuit, the accurate fetching (writing) and reading operations of the input data in the input buffer IBF can be executed.

When the external reference clock φ0 is supplied to the phase comparator PHC, since the PLL circuit operates so as to make the phase of the feedback clock φf coincide with that of the external reference clock φ0, the phase of the produced clock, that is, the clock CLK which is outputted from the frequency divider DVD also coincides with that of the external reference clock φ0. Also in this case, the input buffer IBF fetches (writes) the input data synchronously with the input clock φin. The reading operation of the data from the input buffer IBF is performed synchronously with the read clock R-CLK0 which is outputted from the frequency divider DVD. Therefore, when the phase of the input clock φin is unstable and the more stable clock exists in the outside, by using the external reference clock φ0 as a reference clock of the PLL circuit, the reading operation of the data from the input buffer IBF is normally executed. In this case, however, since the external reference clock φ0 and the input data are asynchronous, the accurate data transfer from the data input terminal to the signal processing circuit is not guaranteed.

In the embodiment, therefore, in a mode in which the external reference clock φ0 is used as a reference clock of the PLL circuit, the reset signal RST is inputted from the AND gate G1 to the input buffer IBF, thereby resetting. When the reset signal RST is inputted, the input buffer IBF operates so as to interrupt the fetching of the data. Thus, the erroneous data transfer is avoided. In place of interrupting the fetching of the data by inputting the reset signal RST, it is also possible to construct in a manner such that the phase of the input clock φin is synchronized with that of the clock CLK from the frequency divider DVD and the data fetching is restarted.

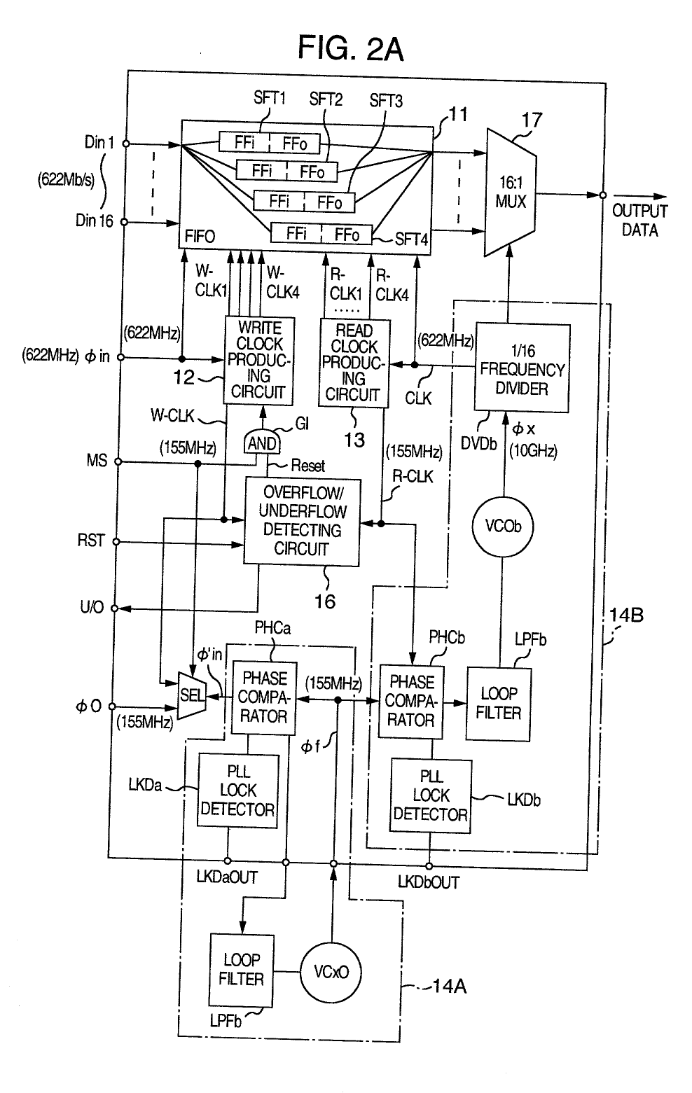

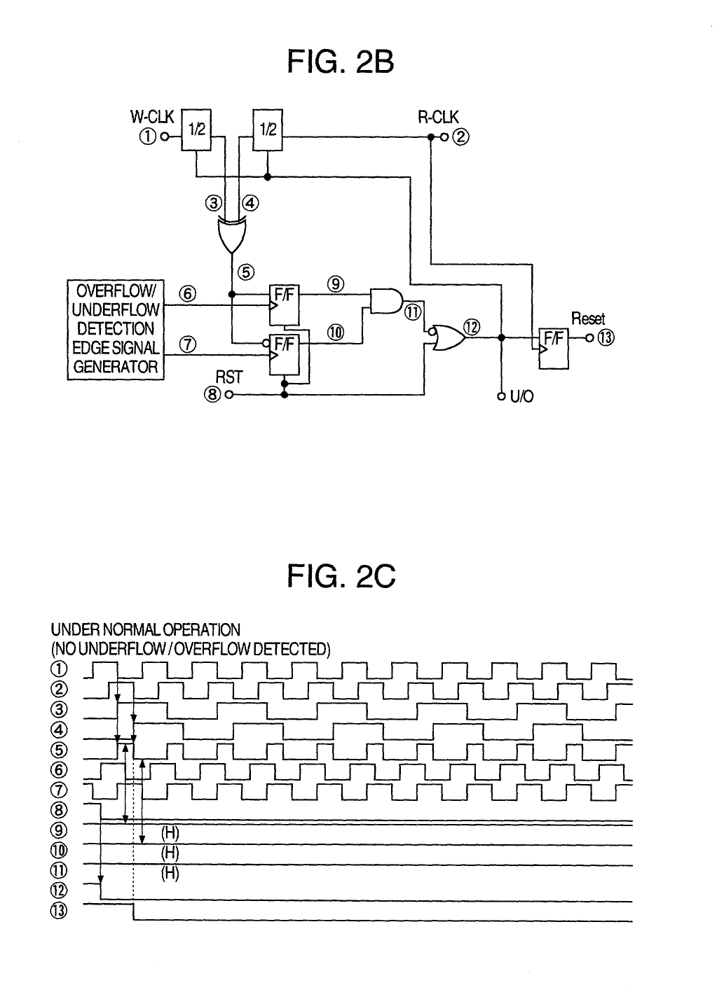

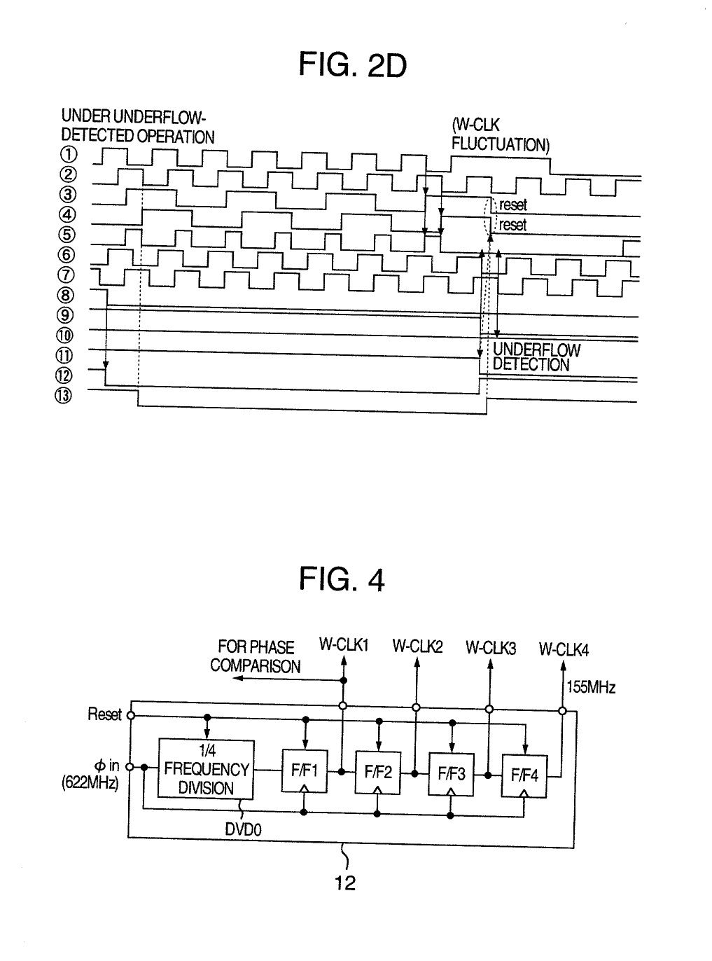

FIG. 2 shows a specific example in the case where the invention is applied to a data transmitting circuit of an LSI (transceiver chip) for optical communication. The data transmitting circuit of the embodiment has a function for multiplexing data signals Din1 to Din16 of 16 channels which are supplied to the input data port and whose transfer rates are equal to 622 Mb/sec into a data signal of 10 GHz and transmitting it. In order to prevent an erroneous operation due to a jitter of the input data fetch clock φin which is supplied to the input clock port, a buffer memory 11 of an FIFO (First-in First-out) system is provided for the data input section. The buffer memory 11 includes four (4 bits) shift registers SFT1 to SFT4 provided in correspondence to each of the 16 channels. Each shift register comprises flip-flops FFi and FFo of two stages of an input stage and an output stage. The four shift registers are made operative at timings which are deviated every timing of one period of the input clock φin, respectively.

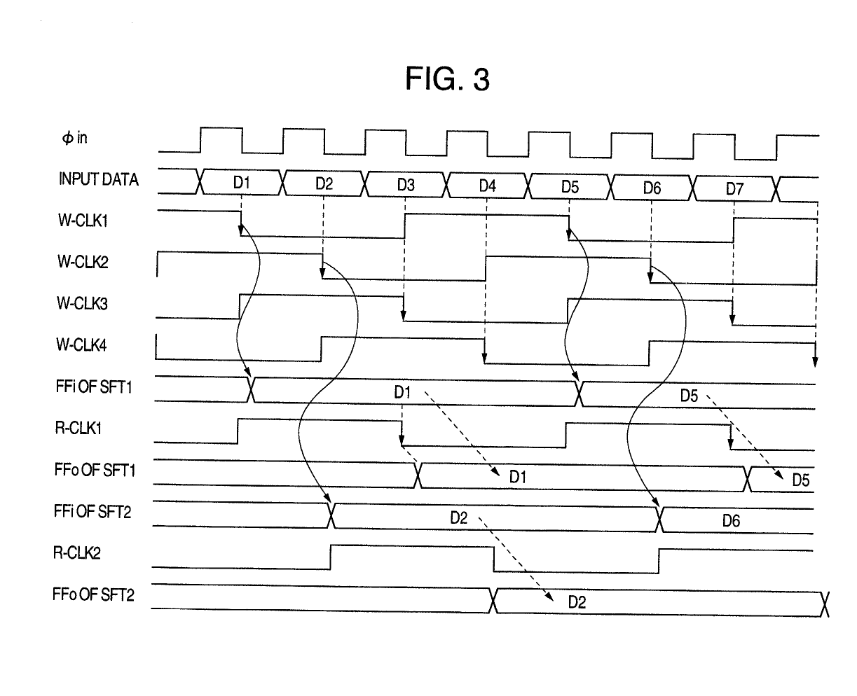

Although not limited particularly, a frequency of the input data fetch clock φin is equal to 622 MHz and this clock is inputted from an LSI constructed by ASIC or the like of a user system (not shown) together with the transmission data Din1 to Din16. There is provided a write clock producing circuit 12 for frequency dividing the input clock φin of 622 MHz into ¼ and producing write clocks W-CLK1 to W-CLK4 of 155 MHz as shown in FIG. 3 which are necessary for allowing the input stages FFi of the shift registers SFT1 to SFT4 of each channel of the buffer memory 11 to execute the latching operation, respectively. There is provided a read clock producing circuit 13 for producing read clocks R-CLK1 to R-CLK4 of 155 MHz for making the output stage FFo of of the shift registers SFT1 to SFT4 of each channel for reading the data written in the buffer memory 11 to operative, respectively.

When the write clocks W-CLK1 to W-CLK4 are supplied to the buffer memory 11, as shown in FIG. 3, bits (D1, D5, D9, . . . ) of the input data are sequentially fetched into the input stage FFi of the shift register SFT1 synchronously with a trailing edge of the write clock W-CLK1, respectively, and are shifted and read out to the output stage FFo of the shift register SFT1 synchronously with a trailing edge of the read clock R-CLK1 at timings which are delayed by the half period, respectively. Bits (D2, D6, D10, . . . ) of the input data are sequentially fetched into the input stage FFi of the shift register SFT2 synchronously with a trailing edge of the write clock W-CLK2, respectively, and are shifted and read out to the output stage FFo of the shift register SFT1 synchronously with a trailing edge of the read clock R-CLK2 at timings which are delayed by the half period, respectively. The same shall also similarly apply to the shift registers SFT3 and SFT4. The shift register SFT3 is made operative by the write clock W-CLK3 and read clock R-CLK3. The shift register SFT4 is made operative by the write clock W-CLK4 and read clock R-CLK4.

In the embodiment, a PLL circuit is provided to give the PLL clock CLK serving as a reference of production of the read clocks R-CLK1 to R-CLK4 in the read clock producing circuit 13. Although not limited particularly, in the embodiment, the PLL circuit for producing the clock CLK serving as a reference is constructed by: a first PLL circuit section 14A for producing an intermediate reference clock of 155 MHz; and a second PLL circuit section 14B for producing a PLL clock φx of 10 GHz on the basis of the intermediate reference clock produced by the PLL circuit section 14A.

A selector 15 is provided at the front stage of the first PLL circuit section 14A. Either the input clock φin or the external reference clock φ0 which is supplied to the external clock port is selected by the selector 15 and supplied to a phase comparator PHCa of the PLL circuit section 14A. In the embodiment, the clock which is supplied to the PLL circuit section 14A through the selector SEL is not the input clock φin itself but the clock W-CLK1 produced by the write clock producing circuit 12 for producing the write clocks W-CLK1 to W-CLK4 on the basis of the input clock φin or a clock W-CLK of 155 MHz of the same period as that of the clock W-CLK1.

The mode selection signal MS which is supplied from the outside to the mode selection signal port is supplied as a switching control signal to the selector 15. The selector 15 operates in a manner such that when the mode selection signal MS is at the high level, the selector 15 supplies the external reference clock φ0 to the phase comparator PHCa of the first PLL circuit section 14A and when the mode selection signal MS is at the low level, the selector 15 supplies the clock W-CLK to the phase comparator PHCa. The mode selection signal MS is inputted as a control signal to the AND gate G1.

Further, in the embodiment, there is provided a detecting circuit 16 for comparing a phase of the data write clock W-CLK produced by the write clock producing circuit 12 with that of the data read clock R-CLK produced by the read clock producing circuit 13 and detecting an overflow or an underflow in which both phases are mutually deviated by one period or more. When the detecting circuit 16 detects the overflow or underflow, a detection signal U/Q is outputted to the outside.

FIG. 2B shows an example of a construction of the overflow/underflow detecting circuit 16. FIG. 2C shows operation waveforms in the case where no overflow/underflow is detected (normal operation). FIG. 2D shows operation waveforms in the case where the underflow is detected. In FIGS. 2B, 2C, and 2D, reference numerals each surrounded by a circle indicate signals described hereinbelow.

\mathring{1} W-CLK (data write clock)

\mathring{2} R-CLK (data read clock)

\mathring{3} ½ frequency division signal of W-CLK

\mathring{4} ½ frequency division signal of R-CLK

\mathring{5} Exclusive OR of the ½ frequency division signal of W-CLK and the ½ frequency division signal of R-CLK

\mathring{6} Underflow detection edge signal

\mathring{7} Overflow detection edge signal

\mathring{8} RST (reset) signal

\mathring{9} Underflow detection internal signal

\mathring{10} Overflow detection internal signal

\mathring{11} Underflow/overflow detection signal (AND output signal of \mathring{9} and \mathring{10})

\mathring{12} Internal reset signal

\mathring{13} Reset (reset signal)

In the circuit of FIG. 2B, the operation (normal operation) in the case where no overflow/underflow is detected will be described by using FIG. 2C. When the input \mathring{8} from an external input RST terminal changes to the low level, the output \mathring{12} of the OR gate changes to the low level and a ½ frequency divider which receives the W-CLK \mathring{1} and R-CLK \mathring{2} starts the operation and outputs \mathring{3} and \mathring{4}, respectively. The exclusive OR output \mathring{5} of \mathring{3} and \mathring{4} is inputted to two flip-flop circuits. The flip-flop circuits receive the underflow detection signal \mathring{6} and overflow detection signal \mathring{7} generated by an overflow/underflow detection edge signal generator as edge signals and execute the normal operations in the case where the detection signals \mathring{6} and \mathring{7} at the high level are latched in response to the signal \mathring{5}. In case of the normal operation (an input of the flip-flop circuit on the overflow detection side is a negative logic input), both outputs \mathring{9} and \mathring{10} of the flip-flop circuits are set to the high level, the AND gate output \mathring{11} of \mathring{9} and \mathring{10} is set to the high level, the OR gate output \mathring{12} of the negative logic of \mathring{11} and \mathring{8} and the Reset output \mathring{13} are held at the low level, and the operation is maintained.

The operation in the case where the underflow is detected in the circuit of FIG. 2B will now be described by using FIG. 2D. In a state where the Reset output \mathring{13} is held at the low level in the normal operation, if the phase of the W-CLK \mathring{1} fluctuates ((W-CLK fluctuation) in the diagram) due to some causes, for example, due to an erroneous operation or the like on the apparatus side which supplies \mathring{1}, a ½ frequency division waveform of \mathring{1} is as shown by \mathring{3}. The R-CLK \mathring{2} and its ½ frequency division waveform \mathring{4} are the same as those in the normal state of FIG. 2C. The exclusive OR output \mathring{5} of \mathring{3} and \mathring{4} is inputted to the two flip-flop circuits. The flip-flop circuits receive the underflow detection signal \mathring{6} and overflow detection signal \mathring{7} generated by the overflow/underflow detection edge signal generator as edge signals and execute the normal operations in the case where the detection signals \mathring{6} and \mathring{7} at the high level are latched in response to the signal ® (an input of the flip-flop circuit on the overflow detection side is a negative logic input). However, just after the W-CLK fluctuation, the flip-flop circuit which receives the underflow detection signal \mathring{6} as an edge signal outputs the underflow detection internal signal \mathring{9} at the low level since the input signal is at the low level. In this instance, although the overflow detection internal signal \mathring{10} is held at the high level, the AND gate output \mathring{11} of \mathring{9} and \mathring{10} is set to the low level, so that the OR gate output \mathring{12} of the negative logic of \mathring{11} and \mathring{8} and the Reset output \mathring{13} are set to the high level. At this time, the internal Reset signal \mathring{12} is inputted as a reset signal to the ½ frequency dividers of \mathring{1} and \mathring{2}. The ½ frequency dividers stop the operation. The signals \mathring{3} and \mathring{4} are fixed to the low level.

The internal Reset signal \mathring{12} in FIG. 2B is outputted as a detection signal U/O in FIG. 2A to an external apparatus. When the detection signal U/O is received, the external apparatus recognizes a fact that the data transfer is not normally performed in the buffer memory 11 in FIG. 2A. In this instance, the external apparatus monitors outputs LKDaOUT and LKDbOUT of PLL lock detectors in FIG. 2A. After these two outputs showing lock detection are outputted, the external apparatus produces a reset release signal RST and sends it to a control signal port. The reset release signal RST is inputted to the overflow/underflow detecting circuit 16 in FIG. 2A and releases the reset of the detecting circuit. An internal reset signal Reset produced on the basis of the reset release signal RST is supplied to the AND gate G1. In the overflow/underflow detecting circuit 16, the internal reset signal Reset is set to a signal whose phase is synchronized with that of the data read clock R-CLK which is produced by the read clock producing circuit 13. This operation is realized by a portion constructed by a flip-flop circuit which receives \mathring{12} as an input, receives the R-CLK \mathring{2} as an edge signal, and outputs the Reset signal \mathring{13} in FIG. 2B.

When the mode selection signal MS inputted to the other terminal of the AND gate G1 is at the high level, the internal reset signal Reset is supplied to the write clock producing circuit 12 through the AND gate G1, the production of the write clocks W-CLK1 to W-CLK4 is inhibited, and the data fetch into the FIFO buffer memory 11 is interrupted.

The first PLL circuit section 14A is constructed by: the phase comparator PHCa for comparing a phase of an output φin′ of the selector SEL with that of the feedback clock φf; a loop filter LPFa comprising a capacitive device which is externally attached; and a voltage controlled oscillator VCXO which is externally attached and oscillates at a frequency near 155 MHz. The reason why the loop filter LPFa and voltage controlled oscillator VCxO are constructed by the devices which are externally attached is to obtain an oscillation signal of high precision.

Although capacitors and resistors which are formed on a semiconductor chip are likely to vary, by constructing the first PLL circuit by using the externally attached devices, the precision of the oscillation signal which is produced is raised and a phase deviation of clocks which are generated can be reduced. By fetching the data into the input buffer and reading it out by using those clocks, the further accurate data transfer can be realized.

The apparatus is provided with a PLL lock detector LKDa for detecting a case where the phases and the frequencies of the two kinds of clocks φin′ and φf which are compared by the phase comparator PHCa are not synchronized, respectively, and the apparatus has a function for outputting a result of the detection to the external apparatus by the signal LKDaOUT.

The second PLL circuit section 14B is constructed by: a phase comparator PHCb for comparing a phase of the oscillation signal φf of the voltage controlled oscillator VCxO of the first PLL circuit section 14A with that of the clock R-CLK synchronized with the read clocks R-CLK1 to R-CLK4 which are supplied from the read clock producing circuit 13; a loop filter LPFb; a voltage controlled oscillator VCOb which oscillates at a frequency near 10 GHz; and a frequency divider DVDb for frequency dividing an oscillation signal of the VCOb into 1/16. The loop filter LPFb and voltage controlled oscillator VCOb constructing the second PLL circuit section 14B are not constructed by the devices which are externally attached but constructed by the devices formed on the semiconductor chip together with the other circuit devices. This is because since the second PLL circuit section 14B receives the oscillation signal of the first PLL circuit section 14A and operates, even if the loop filter LPFb and voltage controlled oscillator VCOb are not constructed by the devices which are externally attached, the oscillation signal of high frequency precision can be produced.

The apparatus is provided with a PLL lock detector LKDb for detecting a case where the phases and the frequencies of the two kinds of clocks φf and R-CLK which are compared by the phase comparator PHCb are not synchronized, respectively, and the apparatus has a function for outputting a result of the detection to the external apparatus by the signal LKDbOUT.

Further, in the embodiment, a demultiplexer 17 for multiplexing the data signals of 622 MHz of 16 channels read out from the buffer memory 11 to the data signal of 10 GHz is provided at the post stage of the FIFO buffer memory 11. The multiplexed data signal is supplied to, for example, a photoelectric converting module for converting an electric signal into a photosignal, converted into the photosignal, and transmitted through an optical fiber.

FIG. 4 shows a specific example of the write clock producing circuit 12. Since the read clock producing circuit 13 also has a similar construction, its description is omitted here. As shown in FIG. 4, the write clock producing circuit 12 is constructed by: a frequency divider DVDO for frequency dividing the input clock φin into ¼; and a shift register comprising flip-flops F/F 1 to F/F 4 in which each output terminal is connected to an input terminal of the circuit at the next stage. A common internal reset signal Reset is supplied to each of the flip-flops F/F 1 to F/F 4 and the input clock φin itself is supplied as a latch timing signal to a clock terminal of each of the flip-flops F/F 1 to F/F 4. Output signals of the flip-flops F/F 1 to F/F 4 are supplied as write clocks W-CLK1 to W-CLK4 to input stages FFi of the shift registers SFT1 to SFT4 of each channel of the FIFO buffer memory 11 with the 4-stage construction.

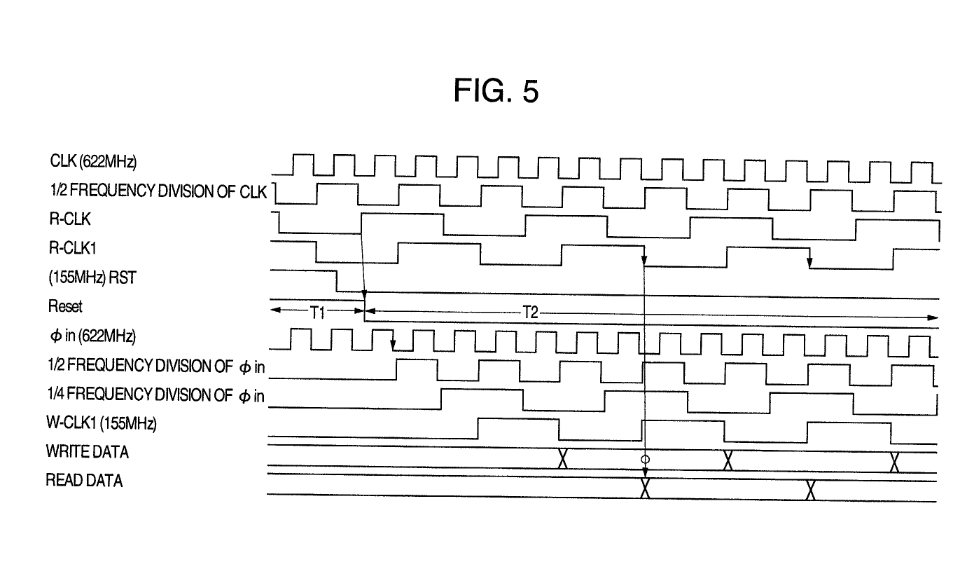

Therefore, as shown in FIG. 3, the write clocks W-CLK1 to W-CLK4 become four kinds of clock signals which have a period that is four times as long as a period of the input clock φin and whose phases are deviated by one period of the input clock φin at a time. By the write clocks W-CLK1 to W-CLK4, in the FIFO buffer memory 11, the input data is sequentially fetched into the shift registers SFT1 to SFT4. When the internal reset signal Reset is invalidated (high level) as shown in a period T1 in FIG. 5, each of the flip-flops F/F 1 to F/F 4 does not perform the latching operation even if the input clock φin changes. Therefore, the write clocks W-CLK1 to W-CLK4 do not change either and the FIFO buffer memory 11 stops the data fetch.

When the internal reset signal Reset is validated (low level) as shown in a period T2 in FIG. 5, each of the flip-flops F/F 1 to F/F 4 performs the latching operation each time the input clock φin changes. Therefore, the write clocks W-CLK1 to W-CLK4 are produced, so that the FIFO buffer memory 11 starts the data fetching operation. Moreover, at this time, by constructing in a manner such that after the reset release signal RST which is supplied from the outside to the control signal port is changed to the low level, the internal reset signal Reset is formed synchronously with the first leading edge of the data read clock RCLK obtained by frequency dividing the reference clock, that is, the PLL clock CLK on the reading side into ¼, even if the PLL clock CLK for reading is asynchronized with the input data fetch clock φin, after the internal reset signal Reset changes to the low level, the frequency divider DVD0 of the write clock producing circuit 12 (FIG. 4) starts the frequency division within one period of the input clock φin, so that the write clocks W-CLK1 to W-CLK4 are produced.

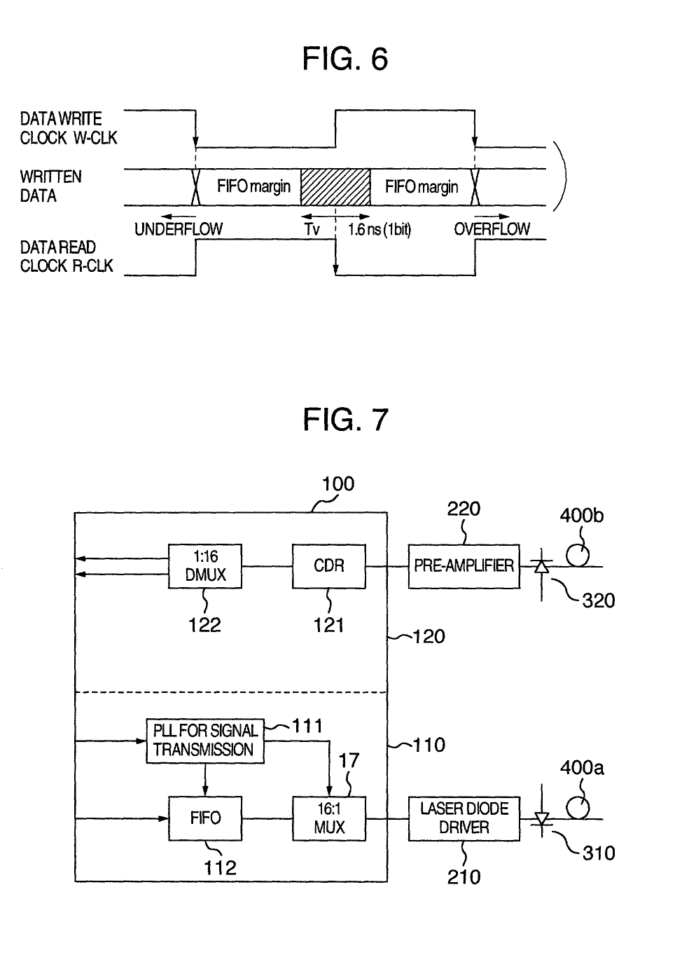

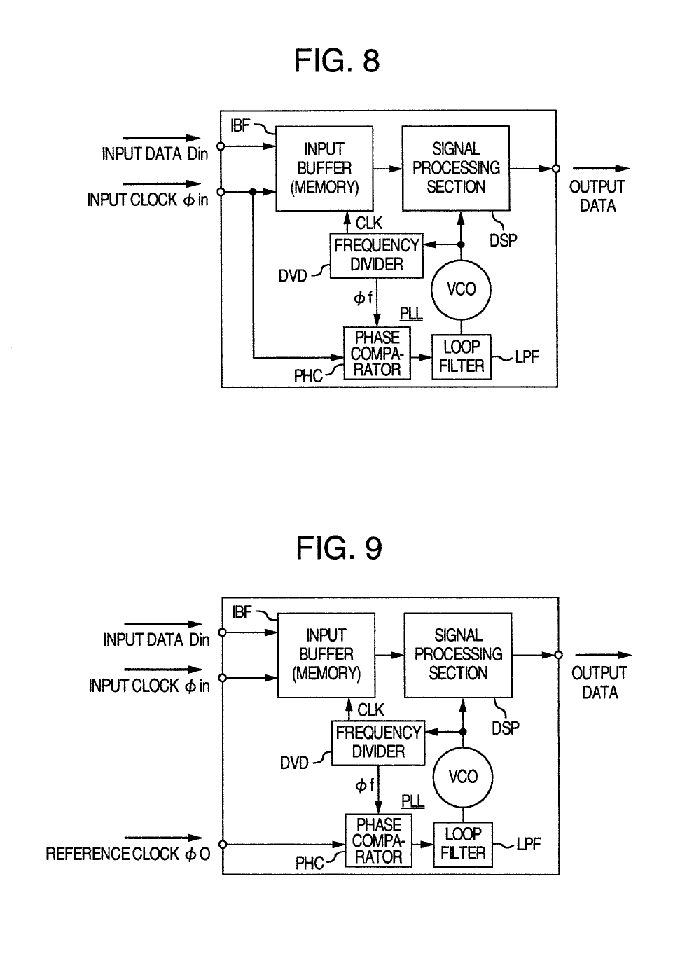

Thus, in the embodiment, even if the read clock, that is, the PLL clock R-CLK is produced on the basis of the stable external reference clock φ0 instead of the unstable input clock φin, the write clocks W-CLK1 to W-CLK4 are controlled so that their phases lie within one period Tv (data 1 bit) of φin as compared with the phase of the read clock R-CLK as shown in FIG. 6. Therefore, just after the release of the reset, even if the PLL is locked in a state where the phase of the PLL clock CLK is deviated most from that of the input clock φin, since the write data into the buffer memory 11 is synchronized with the write clock having the period that is 4 times as long as that of φin, margins each having a period that is 1.5 times as long as that of φin exist before and after a relative fluctuation range of the read clocks R-CLK1 to R-CLK4 as shown in FIG. 6, so that the erroneous data reading is avoided.

Even if the phase of the input clock φin, that is, the write clock is largely deviated from the phase of the clock for reading, that is, the PLL clock CLK during the operation, when the phase is deviated by the half period, the overflow/underflow detecting circuit 16 detects the phase deviation and outputs the detection signal U/O. The external apparatus receives it and inputs the reset release signal RST again. Therefore, the write clock producing circuit 12 once stops the production of the write clock and, thereafter, restarts it, thereby correcting the phase deviation. Thus, even in the mode to produce the read clocks R-CLK1 to R-CLK4 on the basis of the stable external reference clock φ0 instead of the unstable input clock φin, the erroneous data transfer is avoided.

FIG. 7 shows an example of a schematic construction of an LSI (transceiver chip) for optical communication to which the data transmitting circuit in the embodiment is applied.

A transceiver chip 100 in FIG. 7 is constructed by: a signal transmitting section 110 comprising the data transmitting circuit in the embodiment; and a signal receiving section 120 for receiving data. In FIG. 7, a simplified circuit construction is shown. A PLL 111 for signal transmission corresponds to the PLL circuit sections 14A and 14B in FIG. 2. An FIFO 112 corresponds to the buffer memory 11 in FIG. 2. The other circuits such as a write clock producing circuit 12 and the like are not shown. The signal receiving section 120 is constructed by: a circuit (CDR) 121 for shaping a waveform of the received serial data signal, capturing a change in received data signal, and producing the clock; a demultiplexer 122 for separating the multiplexed reception data of 16 channels into data signals of each channel; and the like. A PLL circuit for signal transmission for producing clocks of a stable frequency by using the clocks extracted from the reception data as reference clocks and supplying them to the demultiplexer 122 is provided for the CDR circuit 121.

An LD driver chip 210 for driving a laser diode 310 is connected to an output terminal of the multiplexer 17 of the signal transmitting section 110. The laser diode 310 converts a transmission data signal as an electric signal into a photosignal and outputs it to an optical fiber 400a. A pre-amplifier 220 is connected to an input terminal of the CDR circuit 121 of the signal receiving section 120. The pre-amplifier 220 amplifies the electric signal converted by a photodiode 320 for converting the photosignal received from an optical fiber 400b into an electric signal and supplies it to the input terminal of the CDR circuit 121.

Although the invention made by the inventors has specifically been described above on the basis of the embodiment, the invention is not limited to it. For example, in the embodiment, the write clock producing circuit 12 has been constructed in a manner such that when the reset release signal RST is inputted while the PLL circuit is operating on the basis of the stable external reference clock φ0, the production of the write clock is started on the basis of the clock produced by the read clock producing circuit 13. However, the production of the write clock can be also started on the basis of the clock which is supplied from the frequency divider DVDb in the second PLL circuit section 14B in place of the clock produced by the read clock producing circuit.

Although the explanation has been made above mainly with respect to the case where the invention made by the inventors is applied to the LSI for communication having the clock producing circuit comprising the PLL circuit as a field of utilization as a background, the invention can be also applied to a general semiconductor integrated circuit having a PLL circuit therein.

According to the embodiment mentioned above, in the system in which the phase of the input clock is stable, the read clock can be produced on the basis of the input clock, and in the system in which the phase of the input clock is unstable, the read clock can be produced on the basis of the stable external clock. Thus, as well as the case where the phase of the input clock is stable, even in the case where the phase of the input clock is unstable, the accurate data transfer can be performed. Even if there are a case where the phase of the input clock is stable and a case where the phase of the input clock is unstable in dependence on the construction of the user system using the semiconductor integrated circuit apparatus for communication mentioned above, one LSI can also cope with any of those systems.

In the semiconductor integrated circuit for communication having the buffer for fetching the input data on the basis of the input clock and outputting it, the clock producing circuit which can produce the clock which enables the accurate data transfer even in the case where the phase of the input clock is unstable can be realized. The clock producing circuit which can cope with any of the input clock and the reference clock can be realized.

What is claimed is:

1. A semiconductor integrated circuit apparatus for communication, comprising:
a buffer in which input data is written by a write clock based on an input clock concerned with the input data and from which the written data is read out by a read clock;
clock switching means for selecting either said input clock or a stable external clock which is supplied from an outside on the basis of a selection signal from the outside; and
a circuit for producing the read clock on the basis of an output of said clock switching means,
wherein said read clock producing circuit includes
a PLL circuit for receiving the output of said clock switching means and generating a PLL clock locked with said output and a frequency divider for frequency dividing said PLL clock and generating said read clock.

2. An apparatus according to claim 1, further comprising a write clock producing circuit which can produce said write clock in response to a control signal from the outside and a clock signal based on said PLL clock when the stable external clock which is supplied from said outside is selected by said clock switching means.

3. An apparatus according to claim 2, further comprising a detector for comparing a phase of said write clock from said write clock producing circuit with that of said read clock from said read clock producing circuit and generating a detection signal showing that a phase difference between them is equal to or larger than a predetermined value,
and wherein the control signal from said outside is supplied to said semiconductor integrated circuit apparatus in response to said detection signal.

4. An apparatus according to claim 1, wherein said PLL circuit has a first PLL circuit section for receiving the output of said clock switching means and generating an intermediate reference clock and a second PLL circuit section for receiving said intermediate reference clock and generating said PLL clock, said first PLL circuit section has an externally attached voltage controlled oscillator, and said second PLL circuit section has no externally attached device.

5. An apparatus according to claim 1, wherein said buffer has a construction adapted to transfer serial data of a plurality of channels and said apparatus further has a multiplexer for multiplexing the serial data of said plurality of channels read out from said buffer.

6. A semiconductor integrated circuit apparatus for correctly transferring received data formed with a single semiconductor chip, comprising:
an input data port for receiving input data to the device;
an input clock port for receiving a data fetch clock related to said input data;
an external clock port for receiving a stabilized clock externally of said chip;
a control signal port for receiving a control signal externally of said chip;
an output data port;
a buffer to which the received input data is written with a write clock and from which the written data is read with a read clock for delivery to said output data port, said write clock being normally based on said data fetch clock and being made active or inactive by a control signal received at said control signal port; and
a clock producing circuit for determining said read clock, the clock producing circuit including
a selector for receiving a portion of said data fetch clock from said input clock port and said stabilized clock from said external clock port and passing one of said data fetch clock and stabilized clock as an output, and
a PLL connected to receive the output of said selector and generate a PLL clock locked to said output of said selector, said read clock being based on said PLL clock.

7. A semiconductor integrated circuit apparatus according to claim 6, wherein said PLL includes a first PLL section for generating an intermediary reference clock from said output of said selector and a second PLL section for generating said PLL clock from said intermediary clock, said first PLL section being connected to an oscillator connection port for external connection with a voltage-controlled oscillator, said second PLL having no externally connected element.

8. A semiconductor integrated circuit apparatus for correctly transferring received data formed with a single semiconductor chip, comprising:
an input data port for receiving input data to the device;
an input clock port for receiving a data fetch clock related to said input data;
an external clock port for receiving a stabilized clock externally of said chip;
a control signal port for receiving an external control signal externally of said chip;
a detection signal port;
an output data port;
a buffer to which the received input data is written with a write clock and from which the written data is read with a read clock for delivery to said output data port; and
a clock producing circuit for determining said write clock and said read clock, the clock producing circuit including
means connected to receive said data fetch clock from said input clock port and receive said external control signal from said control signal port for generating from said data fetch clock said write clock under control of said external control signal,
a selector for receiving said write clock from said write clock generating means and said stabilized clock from said external clock port and passing one of said write clock and said stabilized clock as an output,
a PLL connected to receive the output of said selector and generate a PLL clock locked to said output of said selector,
means connected to receive said PLL clock from said PLL for generating therefrom said read clock, and
a detector electrically connected to receive another portion of said write clock from said write clock generating means and a portion of said read clock from said read clock generating means to phase-compare said write clock and read clock for generating, based on a phase comparison result, an internal control signal to be fed to said detection signal port,
said external control signal being supplied to said control signal port responsive to said internal control signal for control of said write clock to make it active or inactive.

9. A semiconductor integrated circuit apparatus according to claim 8, wherein said PLL includes a first PLL section for generating an intermediary reference clock from said output of said selector and a second PLL section for generating said PLL clock from said intermediary clock, said first PLL section being connected to an oscillator connection port for external connection with a voltage-controlled oscillator, said second PLL having no externally connected element.
